(19) United States
(12) Patent Application Publication
(10) Pub. No.: US 2012/0154489 A1
(43) Pub. Date: Jun. 21, 2012

(54) HEAD UNIT, PRINTING DEVICE, AND PRINTING METHOD

(75) Inventor: Teruo NAKAYAMA, Suwa (JP)

(73) Assignee: SEIKO EPSON CORPORATION, Tokyo (JP)

(21) Appl. No.: 13/326,801

(22) Filed: Dec. 15, 2011

(30) Foreign Application Priority Data
Dec. 17, 2010 (JP) 2010-281926

(51) Int. Cl. B41J 2/05

(52) U.S. Cl. 347/57

(57) ABSTRACT

To carry out temperature control of ink in an appropriate manner, the invention includes a head having nozzles; driving elements for carrying out an operation to eject ink from the nozzles on the basis of a drive signal; transistors for generating the drive signal, the transistors emitting heat when the drive signal is generated; and a Peltier element provided correspondingly with respect to the transistors; wherein temperature control of ink inside the head is carried out according to a first heat conduction mode in which heat emitted by the transistors is conducted to the ink inside the head, and a second heat conduction mode in which heat emitted by the transistors is conducted to one of the junctions of the Peltier element, whereby a transition is made to heat absorption at another junction of the Peltier element and heat is conducted to the ink inside the head.

### CROSS-REFERENCE TO RELATED APPLICATIONS

This application claims priority to Japanese Patent Application No. 2010-281926 filed on Dec. 17, 2010. The entire disclosure of Japanese Patent Application No. 2010-281926 is hereby incorporated herein by reference.

### BACKGROUND

1. Technical Field

The present invention relates to a head unit, a printing device, and a printing method.

2. Background Technology

An inkjet printer, which ejects ink from the nozzles of a head unit through driving of driving elements using a drive signal, is one known example of a printing device. Such a printer is provided with a drive signal generating section for generating a drive signal, and the drive signal generating section uses a heat-emitting body (specifically, a transistor) which emits heat when the drive signal is generated. The inks used in printers of this kind have viscosity, and the viscosity and surface tension thereof vary according to temperature. Because of this, there is a risk of ejection characteristics of the inks changing with variations in temperature (particularly temperature in the vicinity of the nozzles ejecting the ink), posing a risk of degrading the image quality. Accordingly, it has been proposed to furnish the head unit with a drive signal generating section, and to utilize the heat emitted by the transistors when the drive signal is generated for temperature management of the ink inside the head (herein, this is also termed temperature control (see Patent Citation 1, for example).

Japanese Patent Application Publication No. 2003-320678 (Patent Citation 1) is examples of the related art.

### SUMMARY

### Problems to Be Solved by the Invention

However, in a printer such as that discussed above, there is a risk of the ink becoming heated excessively due to heat emitted by the transistor, and the risk that, because of this, temperature control of the ink could no longer be carried out in an appropriate manner was a problem. Accordingly, it is an advantage of the invention to carry out temperature control of ink in an appropriate manner.

### Means Used to Solve the Above-Mentioned Problems

The principal invention directed to attaining the aforedescribed advantage resides in a head unit including a head having nozzles; driving elements for carrying out an operation to eject ink from the nozzles on the basis of a drive signal; transistors for generating the drive signal, the transistors emitting heat when the drive signal is generated; and a Peltier element provided correspondingly with respect to the transistors; wherein temperature control of ink inside the head is carried out according to a first heat conduction mode in which heat emitted by the transistors is conducted to the ink inside the head, and a second heat conduction mode in which heat emitted by the transistors is conducted to one of the junctions of the Peltier elements, whereby a transition is made to heat absorption at another junction of the Peltier elements and heat is conducted to the ink inside the head. Other features of the invention will be apparent from the disclosure in the Specification and accompanying drawings.

### BRIEF DESCRIPTION OF THE DRAWINGS

Referring now to the attached drawings which form a part of this original disclosure:

FIG. 1 is a block diagram of the overall configuration of a printer 1;

FIGS. 2A and 2B are drawings showing the internal configuration of the printer 1;

FIG. 3 is a descriptive drawing showing an array of nozzles on the bottom face of a head 41;

FIG. 4 is a drawing showing a configuration of a drive signal generating section 48;

FIG. 5 is a descriptive drawing of operation of the drive signal generating section 48;

FIG. 6 is a descriptive drawing of a configuration of a head control section HC; and

FIG. 7 is a sectional view of a region around a nozzle of the head 41.

### DETAILED DESCRIPTION OF EXEMPLARY EMBODIMENTS

At a minimum, the following will be apparent from the disclosure of the Specification and accompanying drawings.

There will be apparent a head unit including a head having nozzles; driving elements for carrying out an operation to eject ink from the nozzles on the basis of a drive signal; transistors for generating the drive signal, the transistors emitting heat when the drive signal is generated; and Peltier elements provided correspondingly with respect to the transistors; wherein temperature control of ink inside the head is carried out according to a first heat conduction mode in which heat emitted by the transistors is conducted to the ink inside the head, and a second heat conduction mode in which heat emitted by the transistors is conducted to one of the junctions of the Peltier elements, whereby a transition is made to heat absorption at another junction of the Peltier elements and heat is conducted to the ink inside the head. According to this head unit, temperature control of ink can be carried out in an appropriate manner.

In preferred practice, the head unit includes a detection section for detecting the temperature of the transistors; and

the second heat conduction mode is used in a case where a detection result of the detection section exceeds a threshold value. According to this head unit, the ink is not excessively heated.

In preferred practice, in the head unit, the transistors and the Peltier elements are provided to the head interposed by a heat-dissipating body. According to this head unit, heat can be conducted efficiently to the ink inside the head.

In preferred practice, in the head unit, a spacing between the Peltier elements and the nozzles is smaller than a spacing between the transistors and the nozzles. According to this head unit, cooling performance can be enhanced.

Additionally, there will be apparent a printing device including a head having nozzles; driving elements for carrying out an operation to eject ink from the nozzles on the basis of a drive signal; transistors for generating the drive signal, the transistors being provided to the head and emitting heat when the drive signal is generated; and Peltier elements provided to the head correspondingly with respect to the transistors; wherein temperature control of ink inside the head is carried out according to a first heat conduction mode in which heat emitted by the transistors is conducted to the ink inside the head, and a second heat conduction mode in which heat emitted by the transistors is conducted to one of the junctions of the Peltier elements, whereby a transition is made to heat absorption at another junction of the Peltier elements and heat is conducted to the ink inside the head.

Additionally, there will be apparent a printing method for a printing device including a head having nozzles for ejecting ink; driving elements for carrying out an operation to eject ink from the nozzles; transistors provided to the head; and Peltier elements provided correspondingly with respect to the transistors; wherein the printing method has the steps of: using the transistors and generating a drive signal; controlling the temperature of ink inside the head according to a first heat conduction mode in which heat emitted by the transistors when the drive signal is generated is conducted to the ink inside the head, and a second heat conduction mode in which the heat emitted by the transistors when the drive signal is generated is conducted to one end of the Peltier elements, a transition is made to heat absorption at another end of the Peltier elements and heat is conducted to the ink inside the head; and driving the driving elements according to the drive signal so that ink is ejected from the nozzles of the head.

The description of the following embodiment takes the example of an inkjet printer (herein also referred to as printer 1).

### Configuration of Printer

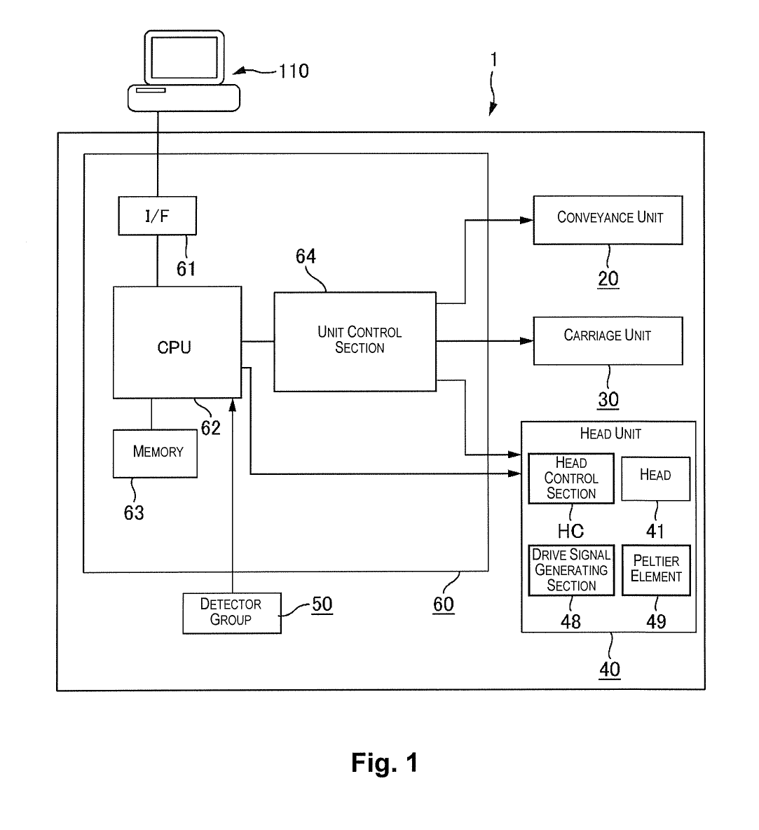

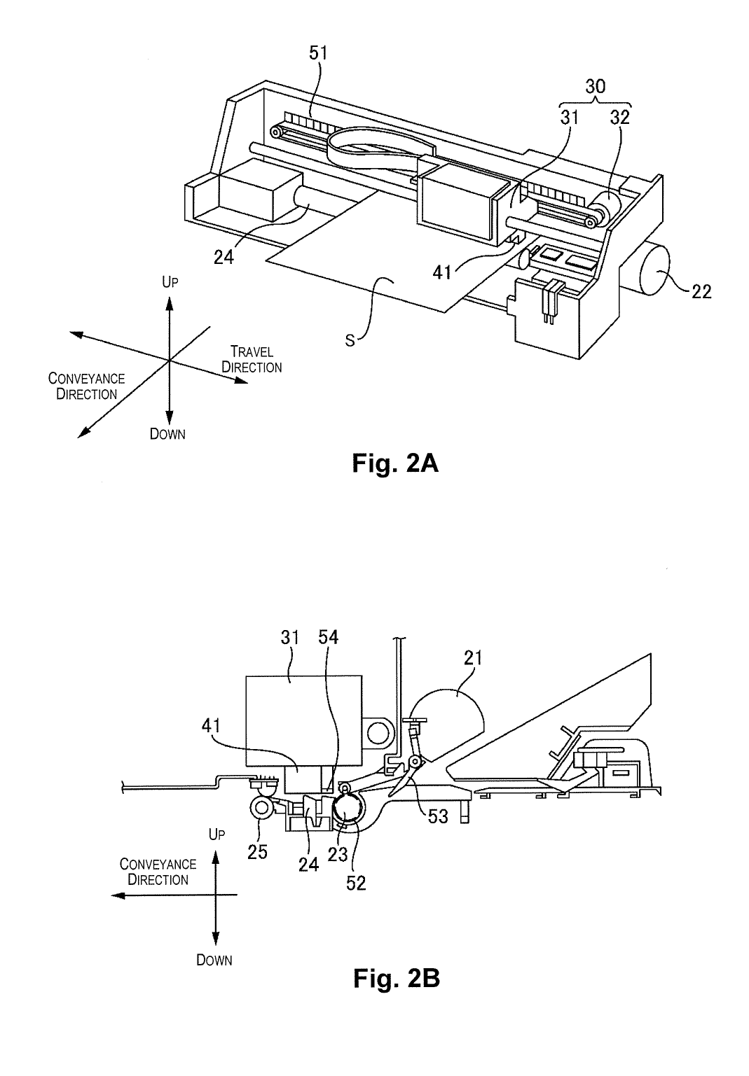

FIG. 1 is a block diagram of the overall configuration of the printer 1 of the present embodiment. FIGS. 2A and 2B are drawings showing the internal configuration of the printer 1. FIG. 2A is a perspective view of the printer 1, and FIG. 2B is a transverse sectional view of the printer 1. The basic configuration of the printer 1 of the present embodiment is described below.

The printer 1 of the present embodiment has a conveyance unit 20, a carriage unit 30, a head unit 40, a detector group 50, and a controller 60. When the printer 1 has received print data from an external device, namely, a computer 110, the various units (the conveyance unit 20, the carriage unit 30, and the head unit 40) are controlled by the controller 60. On the basis of the print data received from the computer 110, the controller 60 controls the various units, and prints images onto a medium. Conditions inside the printer 1 are monitored by the detector group 50, and the detector group 50 outputs the detection results to the controller 60. The controller 60 controls the various units on the basis of the detection results output from the detector group 50.

The purpose of the conveyance unit 20 is to convey a medium (for example, paper or the like) in a predetermined direction (herein termed the conveyance direction). The conveyance unit 20 has a paper supply roller 21, a conveyance motor 22 (also termed a PF motor), a conveyance roller 23, a platen 24, and a paper discharge roller 25. The paper supply roller 21 is a roller for supplying a medium that has been inserted into a paper insertion port into the printer. The conveyance roller 23 is a roller for conveying to a printable area the medium that has been supplied by the paper supply roller 21, and is driven by the conveyance motor 22. The platen 24 supports the medium during printing. The paper discharge roller 25 is a roller for ejecting the medium from the printer to the outside, and is furnished to the downstream side of the printable area in the conveyance direction.

The purpose of the carriage unit 30 is to bring about travel (also called “scanning”) of the head in a predetermined direction (herein called the travel direction). This travel direction is a direction intersecting the conveyance direction. The carriage unit 30 has a carriage 31 and a carriage motor 32 (also called a CR motor). The carriage 31 is capable of reciprocating travel in the travel direction, and is driven by the carriage motor 32. The carriage 31 detachably retains an ink cartridge containing ink.

The purpose of the head unit 40 is to eject ink onto the medium. The head unit 40 is provided with a head 41 having a plurality of nozzles; a head control section HC, a drive signal generating section 48, and Peltier elements 49. Because the head 41 is furnished to the carriage 31, as the carriage 31 travels in the travel direction, the head 41 travels in the travel direction as well. Through intermittent ejection of ink during travel of the head 41 in the travel direction, dot lines (raster lines) are formed along the travel direction on the medium. The configurations of the head unit 40 are discussed in detail below.

The detector group 50 includes a linear encoder 51, a rotary encoder 52, a paper detection sensor 53, an optical sensor 54, and the like. The linear encoder 51 detects the position of the carriage 31 in the travel direction. The rotary encoder 52 detects the amount of rotation of the conveyance roller 23. The paper detection sensor 53 detects the position of the leading edge of the medium being supplied. The optical sensor 54 detects the presence or absence of the medium, with a light-emitting section and a light-receiving section which are attached to the carriage 31. The optical sensor 54 can detects the position of the edge sections of the medium while traveling with the carriage 31, and detect the width of the medium. Depending on conditions, the optical sensor 54 can also detect the leading edge (the edge section to the downstream side in the conveyance direction, also termed the top edge) and the trailing edge (the edge portion to the upstream side in the conveyance direction, also termed the bottom edge) of the medium.

In the present embodiment, the detector group 50 is one having a temperature sensor (for example, a thermistor, corresponding to the detection section) furnished in proximity to transistors (discussed below) of the drive signal generating section 48, for detecting the temperature of the transistors in question.

The controller 60 is a control unit for carrying out control of the printer. The controller 60 has an interface section 61, a CPU 62, a memory 63, and a unit control section 64. The interface section 61 carries out sending and receiving of data between an external device, i.e., the computer 110, and the printer 1. The CPU 62 is an arithmetic processing device for carrying out control of the entire printer. The purpose of the memory 63 is to allocate an area for saving programs for the CPU 62, as well as a work area and the like, and has storage elements such as RAM, EEPROM, or the like. The CPU 62 controls the units via the unit control section 64, in accordance with a program stored in the memory 63.

### (Regarding the Printing Procedure)

Upon receiving a print command and print data from the computer 110, the controller 60 analyzes the content of various commands included in the print data, and using the units, carries out the following process.

First, the controller 60 rotates the paper supply roller 21 and feeds the medium for printing (paper S) to the location of the conveyance roller 23. Next, the controller 60 rotates the conveyance roller 23 by driving the conveyance motor 22. As the conveyance roller 23 rotates by a predetermined rotation amount, the paper S is conveyed by a predetermined conveyance amount.

Once the paper S has been conveyed to below the head unit 40, the controller 60 rotates the carriage motor 32 on the basis of the print command. In response to this rotation of the carriage motor 32, the carriage 31 travels in the travel direction. Also, through travel of the carriage 31, the head unit 40 furnished on the carriage 31 travels simultaneously in the travel direction. During the interval that the head unit 40 is traveling in the travel direction, the controller 60 prompts the drive signal generating section 48 to generate a drive signal COM, and the drive signal COM is applied to piezo elements of the head 41. In so doing, ink drops are ejected intermittently from the head 41 during the interval that the head unit 40 is traveling in the travel direction. As these ink drops land on the paper S, the ink drops form dot rows of a plurality of dots lined up in the travel direction. A dot formation operation by ejection of ink from the traveling head 41 is termed a pass.

Also, the controller 60 drives the conveyance motor 22 during the interim between reciprocating travel of the head unit 40. The conveyance motor 22 produces drive power in a rotation direction, depending on a drive amount instructed by the controller 60. The conveyance motor 22 then uses this drive power to rotate the conveyance roller 23. As the conveyance roller 23 rotates by a predetermined rotation amount, the paper S is conveyed by a predetermined conveyance amount. That is, the conveyance amount of the paper S is determined depending on the amount of rotation of the conveyance roller 23. Passes and conveyance operations are carried out repeatedly in alternating fashion thusly, forming dots on pixels on the paper S. An image is printed on the paper S in this fashion.

Then, finally, using the paper discharge roller 25 which rotates in synchronization with the conveyance roller 23, the controller 60 ejects the paper S once printing has finished.

### Configuration of Head Unit

As discussed previously, the head unit 40 of the present embodiment has a head 41, a head control section HC, a drive signal generating section 48, and Peltier elements 49. The configurations of these are described in detail below.

### (Regarding the Head)

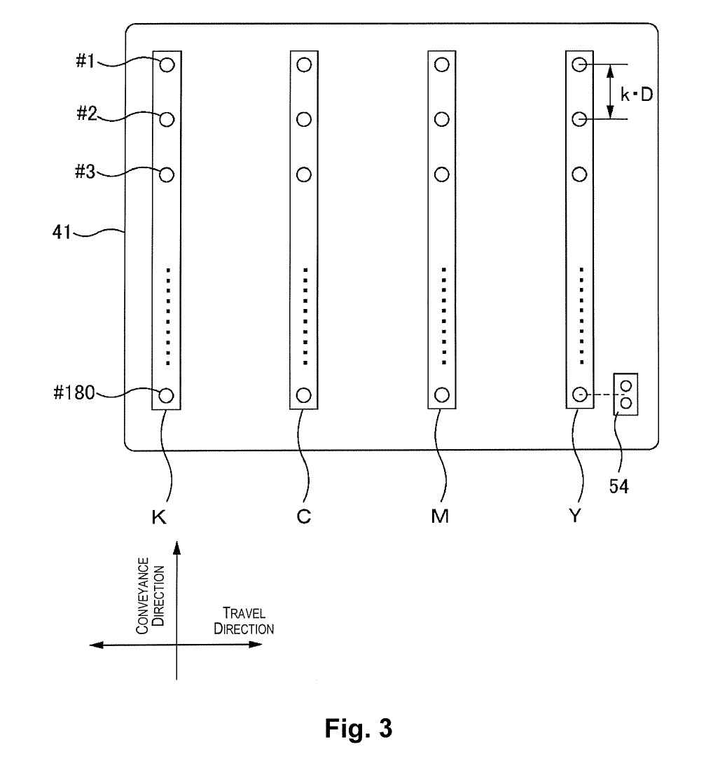

FIG. 3 is a descriptive drawing showing an array of nozzles on the bottom face of the head 41. As shown in FIG. 3, on the bottom face of the head 41 there are formed a black ink nozzle row K, a cyan ink nozzle row C, a magenta ink nozzle row M, and a yellow ink nozzle row Y which line up in the travel direction. Each of the nozzle rows is provided with a plurality of nozzles (180 in the present embodiment) which serve as ejection ports for ejecting ink of each color.

The plurality of nozzles of each nozzle row are respectively aligned to line up at a given spacing (nozzle pitch: k•D) along the conveyance direction. Here, D is the minimum dot pitch in the conveyance direction (that is, the spacing at the highest resolution at which dots are formed on the paper S). k is an integer equal to 1 or greater. For example, in a case where the nozzle pitch is 180 dpi ( 1/180 inch), and the dot pitch in the conveyance direction is 720 dpi ( 1/720), k=4.

The nozzles of each nozzle row are assigned numbers that are smaller for nozzles further toward the downstream side (#1 to #180). That is, nozzle #1 is positioned to the downstream side of nozzle #180 in the conveyance direction. The nozzles are respectively furnished with corresponding driving elements (piezo elements 417, discussed below) for driving the nozzles to eject ink drops. The optical sensor 54 is at substantially the same position as the first nozzle #180 at the upstream side, in relation to position in the conveyance direction.

### (Regarding the Drive Signal Generating Section)

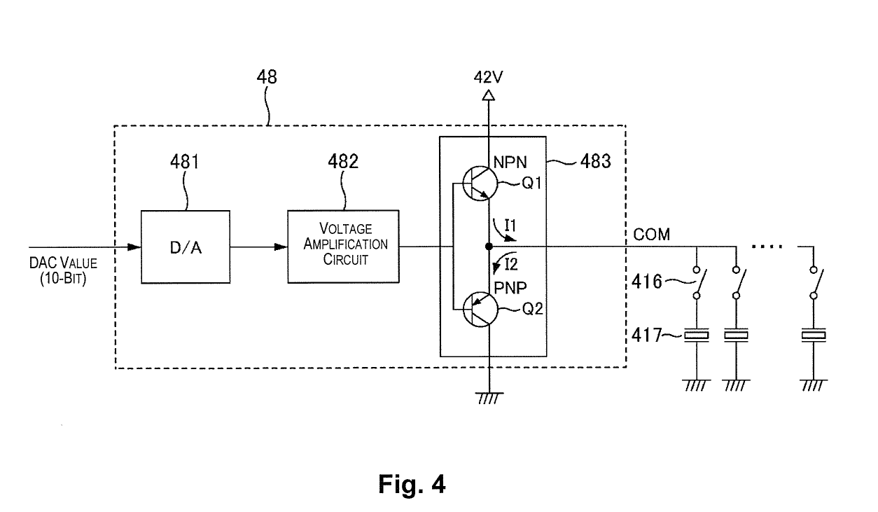

The drive signal generating section 48 generates a drive signal COM for driving the driving elements (piezo elements 417). FIG. 4 is a drawing showing an example configuration of the drive signal generating section 48. As shown in FIG. 4, the drive signal generating section 48 of the present embodiment has a D/A converter 481, a voltage amplification circuit 482, and a current amplification circuit 483. An output signal line for the drive signal COM from the drive signal generating section 48 connects respectively to the plurality of piezo elements 417 via switches 416.

The D/A converter (herein also termed the DAC) 481 converts digital data from the controller 60 (for example, 10-bit digital data) to an analog signal. The voltage amplification circuit 482 amplifies the voltage of the analog signal to a voltage suitable for operating the piezo elements 417, and generates a primary drive signal.

The current amplification circuit 483 carries out current amplification of the primary drive signal, and generates a drive signal COM. As shown in FIG. 4, the current amplification circuit 483 has a transistor pair, namely, an NPN-type bipolar transistor Q1 (herein simply termed transistor Q1) and a PNP-type bipolar transistor Q2 (herein simply termed transistor Q2), whose emitter terminals are connected to one another. The transistor Q1 is a transistor that operates during a rise in voltage of the primary drive signal. The collector of this transistor Q1 is connected to a power supply (42 V), while the emitter is connected to the output signal line for the drive signal COM, respectively. The transistor Q2 is a transistor that operates during a fall in voltage of the primary drive signal. The collector of the transistor Q2 is grounded (earthed), while the emitter is connected to the output signal line for the drive signal COM. The primary drive signal from a voltage amplification circuit 482 is applied to the base of both the transistor Q1 and the transistor Q2.

The operation of the current amplification circuit 483 is controlled by the output voltage of the voltage amplification circuit 482 (the voltage of the primary drive signal). For example, when output voltage is in a rising state, the transistor Q1 enters the ON state. In association therewith, the voltage of the drive signal COM rises as well. On the other hand, when output voltage is in a falling state, the transistor Q2 enters the ON state. In association therewith, the voltage of the drive signal COM falls as well. In cases where the output voltage is constant, both the transistor Q1 and the transistor Q2 are in the OFF state. As a result, the drive signal COM is also a constant voltage.

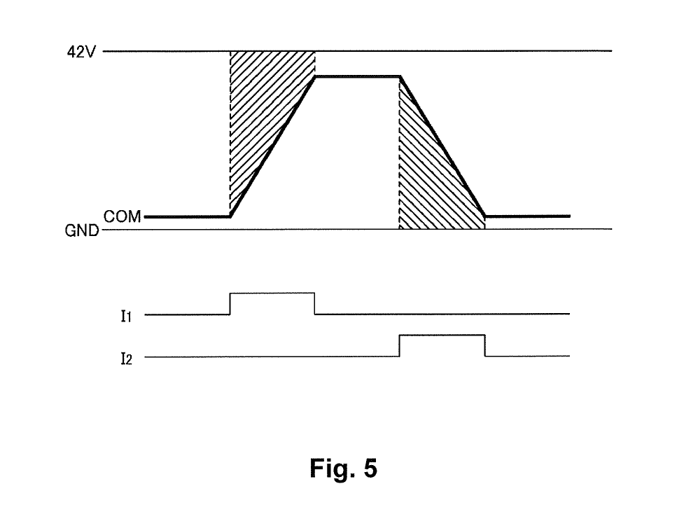

Next, the operation of the drive signal generating section 48 is described. FIG. 5 is a descriptive drawing of the operation of the drive signal generating section 48.

### (During Charging)

When the piezo elements 417 are charging, the voltage of the primary drive signal from the DAC 481 becomes progressively higher. Because of this, the transistor Q1 turns ON, and current I1 flows in the manner shown in the drawing to charge the piezo elements 417. At this time, the amount of heat emitted by the transistor Q1 (the power consumption) is expressed by the product of the current I1 and the collector-emitter voltage of the transistor Q1. That is, it is the product of the current I1 and the shaded section at left (portion with upward-sloping hatching) in FIG. 5.

### (During Holding)

During holding, the voltage of the primary drive signal does not vary. Because of this, both the transistor Q1 and the transistor Q2 are OFF. Therefore, there is no current flow, and the drive signal COM maintains the same voltage.

### (During Discharge)

When the piezo elements 417 discharge, the voltage of the primary drive signal from the DAC 481 becomes progressively lower. Because of this, the transistor Q2 turns ON, and current I2 flows in the manner shown in the drawing to discharge the piezo elements. At this time, the amount of heat emitted by the transistor Q2 (the power consumption) is expressed as the product of the current I2 and the collector-emitter voltage of the transistor Q2. That is, it is the product of the current I2 and the shaded section at right (portion with downward-sloping hatching) in FIG. 5.

During charge and discharge of the piezo elements 417 (in other words, when the drive signal is generated COM) in this manner, the transistor Q1 and the transistor Q2 emit heat. The amount of heat emitted is very large as compared with the amount of heat emitted by other heat-emitting bodies in the printer 1 (for example, the motor driver). Accordingly, in the printer 1 of the present embodiment, the drive signal generating section 48 is provided to the head unit 40, and the heat emitted by the transistor pair (in the present embodiment, the transistor Q1) is utilized for temperature management (temperature control) of the ink, as will be discussed below.

### (Regarding the Head Control Section)

The head control section HC is a control IC provided to the head 41, for controlling driving of the piezo elements 417 and the like. In response to a head control signal from the controller 60, the head control section HC selectively drives the piezo elements 417 corresponding to the nozzles of the head 41. In so doing, ink is ejected from the nozzles of the head 41.

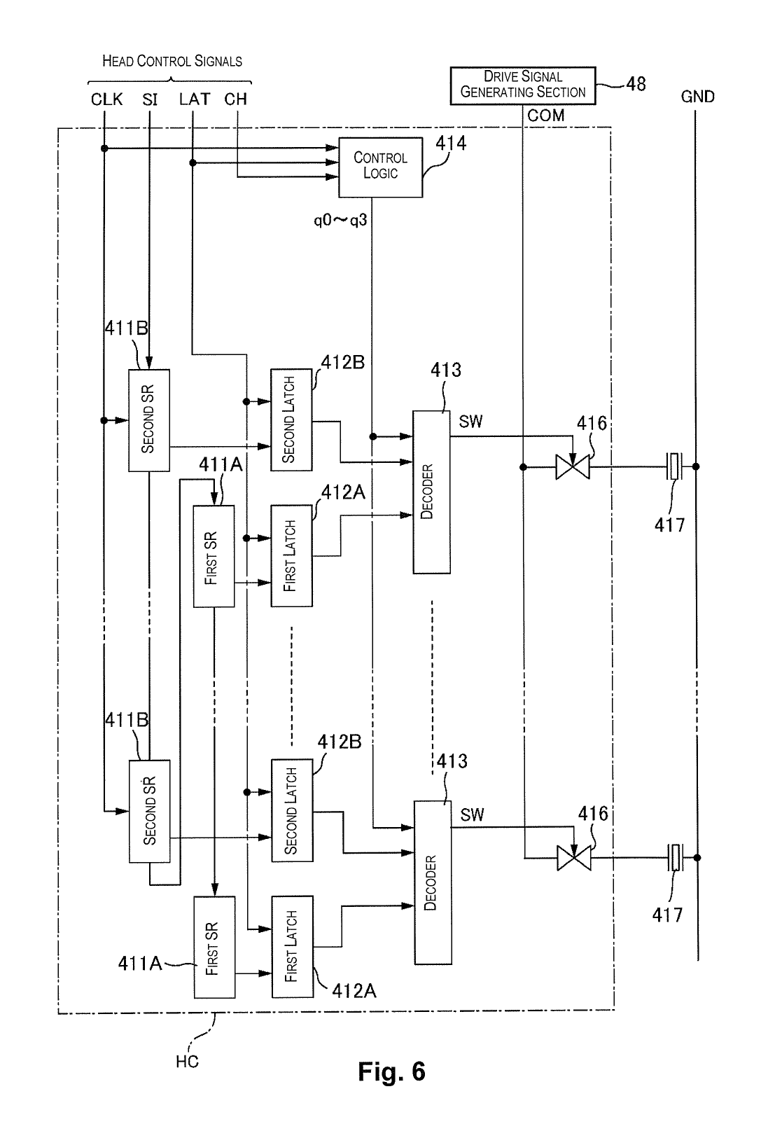

FIG. 6 is a descriptive drawing of an example configuration of the head control section HC. As shown in FIG. 6, the head control section HC is provided with a first shift register 411A, a second shift register 411B, a first latch circuit 412A, a second latch circuit 412B, a decoder 413, control logic 414, and a switch 416. Sections except for the control logic 414 (specifically, the first shift register 411A, the second shift register 411B, the first latch circuit 412A, the second latch circuit 412B, the decoder 413, and the switch 416) are furnished respectively to every one of the piezo elements 417. The piezo elements 417 are elements which are driven in order to eject ink from the nozzles, and are furnished in every one of the nozzles in the head 41.

To the head control section HC are input a latch signal LAT, a change signal CH, pixel data SI, and a clock signal CLK. These signals are described briefly below.

The change signal CH is a signal showing a period of a repeating cycle T (a period in which the head 41 travels through a single pixel interval) divided into equal parts (for example, into three equal parts). The change signal CH is generated by the controller 60 on the basis of a signal from the linear encoder 51, and is input to the control logic 414. The pixel data SI is a signal showing a tone (no dot, a small dot, a medium dot, or a large doe) for every one of the pixels. This pixel data is configured of two bits for each single nozzle. For example, in the case of a nozzle count of 180, during every repeating cycle T, pixel data SI equivalent to 2 bits×180 is sent wirelessly from the device main unit side. The pixel data SI is input to the first shift register 411A and the second shift register 411B. The clock signal CLK is a signal that is used when the pixel data SI sent from the controller 60 is set in the shift registers (the first shift register 411A and the second shift register 411B). The drive signal COM generated by the drive signal generating section 48 is input to the head control section HC as well.

Next, the signals generated by the head control section HC are described. Selection signals q0 to q3, a switch control signal SW, and a voltage application signal are generated by the head control section HC.

The selection signals q0 to q3 are generated by the control logic 414 on the basis of the latch signal LAT and the change signal CH. The selection signals q0 to q3 so generated are then input respectively to the decoders 413 furnished to every one of the piezo elements 417. The switch control signals SW are selected by the decoders 413 from any of the selection signals q0 to q3, on the basis of pixel data (2 bits) latched in the latch circuits (the first latch circuit 412A and the second latch circuit 412B). The switch control signals SW generated by the decoders 413 are respectively input to the corresponding switches 416. Voltage application signals are output from the switches 416 on the basis of the drive signal COM and the switch control signals. The voltage application signals are respectively applied to the switches 416 and to the corresponding piezo elements 417.

Next, the operation of the head control section HC is described. The head control section HC carries out control to eject ink, on the basis of the pixel data SI from the controller 60. Specifically, the head control section HC performs ON/OFF control of the switches 416 on the basis of the print data, and selectively applies to the piezo elements 417 the necessary waveform sections of the drive signal COM. In other words, the head control section HC controls the driving of the piezo elements 417. In the present embodiment, the pixel data SI is composed of two bits. This pixel data SI is then sent to the head 41, in synchronization with a transfer clock CLK. Further, a group of the highest-order bits of the pixel data SI is set in each first shift register 411A, while a group of the lowest-order bits is set in each second shift register 411B. The first latch circuits 412A are electrically connected to the first shift registers 411A, and the second latch circuits 412B are electrically connected to the second shift registers 411B. When the latch signal LAT from the controller 60 goes to H level, each first latch circuit 412A latches the corresponding highest-order bit of the pixel data SI, and each second latch circuit 412B latches the lowest-order bit of the pixel data SI. The pixel data SI (the combinations of highest-order bits and lowest-order bits) latched by the first latch circuits 412A and the second latch circuits 412B are respectively input to the decoders 413. From among the selection signals q0 to q3 output from the control logic 414, the decoders 413 select one selection signal (for example, the selection signal q1) depending on the pixel data SI that was latched in the first latch circuits 412A and the second latch circuits 412B, and output the selected selection signals as the switch control signals SW. The switches 416 are turned ON/OFF depending on the switch control signals SW, and waveform sections included in the drive signal COM are selectively applied to the piezo elements 417.

### (Regarding the Peltier Elements)

The Peltier elements 49 are furnished in correspondence with the transistor pair (in the present embodiment, the transistor Q1) of the drive signal generating section 48. The Peltier elements 49 are formed by joining two different metals (not shown) at two junctions, and when electric current is flowed to the junction portions of the two different metals, heat is emitted at one junction, while heat is absorbed at the other junction (the Peltier effect). When a junction of the two different metals of the Peltier elements 49 discussed above is furnished with a temperature differential, voltage is generated (the Seebeck effect). The ink temperature management process using the Peltier elements 49 is discussed in detail below.

### Regarding Configuration of Region Around Nozzles

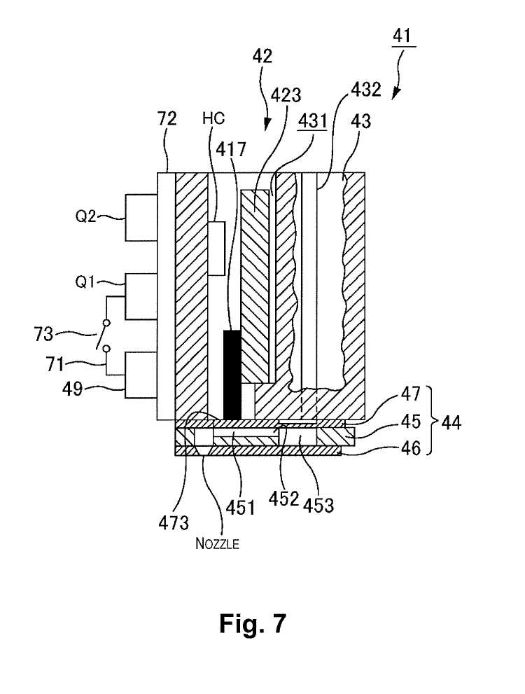

FIG. 7 is a sectional view of an region around a nozzle of the head 41. The head 41 shown in FIG. 7 is provided with a drive unit 42, a case 43 for housing the drive unit 42, and a flow channel unit 44 mounted on the case 43. The head 41 is also furnished with a heat-dissipating panel 72, the transistor Q1, the transistor Q2, and the Peltier elements 49.

The drive unit 42 has a group of piezo elements composed of the plurality of piezo elements 417, and a fastening panel 423 to which the group of piezo elements are fastened. The piezo elements 417 are attached to the fastening panel 423 in a so-called cantilevered state. The fastening panel 423 is a panel-shaped member provided with rigidity commensurate with reaction force from the piezo elements 417. The drive unit 42 is furnished with the head control section HC discussed earlier as well.

The contours of the case 43 are of cuboid block shape having a housing space section 431 able to house the drive unit 42. The flow channel unit 44 is joined to the distal end face of this case 43. The size of this housing space section 431 is such that the drive unit 42 is precisely fittable therein. An ink supply channel 432 is formed in this case 43 as well. The ink supply channel 432 is a supply channel for supplying ink contained in an ink cartridge to a reservoir 453.

The flow channel unit 44 has a flow channel-forming substrate 45, a nozzle plate 46, and an elastic panel 47, which are integrally configured by being respectively stacked with the flow channel-forming substrate 45 sandwiched by the nozzle plate 46 and the elastic panel 47. The nozzle plate 46 is a thin plate of stainless steel with nozzles formed therein.

A plurality of hollow sections to serve as pressure chambers 451 and ink supply ports 452 are formed in the channel-forming substrate 45, in correspondence with the nozzles. The reservoir 453 is a liquid containment chamber for supplying ink contained in an ink cartridge to the pressure chambers 451, and through the ink supply ports 452 communicates with the corresponding pressure chambers 451 at the other end thereof. The ink from the ink cartridge is introduced into the reservoir 453 through the ink supply channel 432.

The drive unit 42 is inserted into the housing space section 431 in a state with the free end sections of the piezo elements 417 facing toward the flow channel unit 44 side, and the distal end faces of the free end sections are bonded to corresponding insular sections 473. The back face of the fastening panel 423 is bonded to an inside wall face of the case 43 partitioning the housing space section 431. In this housed state, when the drive signal COM is supplied to the piezo elements 417, the piezo elements 417 extend and contract, causing the volume of the pressure chambers 451 to expand and constrict. Due to the variation in volume of the pressure chambers 451, pressure fluctuations are produced in the ink inside the pressure chambers 451. Ink drops can then be ejected from the nozzles by utilizing these fluctuations in ink pressure.

The transistor pair (transistors Q1, Q2) of the drive signal generating section 48, as well as the Peltier elements 49, are furnished to the head 41 via the heat-dissipating panel 72. The head 41 is furnished with a plurality of respectively corresponding transistor pairs and Peltier elements 49.

The heat-dissipating panel 72 is a metal panel made of aluminum or iron, and carries out cooling of a heat-emitting body (in this case, the transistor pair) through escape of heat generated by the heat-emitting body.

One of the junctions of the Peltier element 49 is connected to the transistor Q1 via a heat-transfer member 71 with high heat conductivity. Also, as shown in FIG. 7, a switch 73 is formed in the heat-transfer member 71. When the switch 73 is ON, heat is conducted between the transistor Q1 and the Peltier element 49 by the heat-transfer member 71. On the other hand, when the switch 73 is OFF, conduction of heat is not carried out by the heat-transfer member 71. In the present embodiment, the head control section HC carries out ON/OFF control of the switch 73.

The other junction of the Peltier element 49 is connected to the heat-dissipating panel 72.

Further, in the present embodiment, a thermistor (not shown) for detecting the temperature of the transistor Q1 is furnished in proximity to the transistor Q1.

### Regarding Ink Temperature Management

The inks used in the printer 1 have viscosity, and the viscosity and surface tension thereof vary according to temperature. Because of this, there is a risk of the ejection characteristics of the inks changing with variations in temperature (particularly temperature in the vicinity of the nozzles ejecting the ink). For example, in cases where, at low temperature, ink viscosity becomes high and the predetermined ejection characteristics cannot be obtained, there is a risk of degraded image quality. In such cases, it may be contemplated to use heating equipment, such as a heater or the like, to raise the temperature of the ink. However, if a heater is used, the amount of power consumed will increase. Accordingly, in the present embodiment, the heat emitted by the transistor pair of the drive signal generating section 48, which among the heat-emitting bodies of the printer 1 has the greatest amount of heat emission, are utilized for temperature management of the ink. Because of this, in the present embodiment, the drive signal generating section 48 is provided to the head unit 40.

If the drive signal generating section 48 were furnished on the controller 60 side, the emitted heat generated by the transistor pair when the drive signal is generated COM could not be utilized for temperature management of the ink of the head 41. In contrast to this, according to the present embodiment, because the drive signal generating section 48 has been provided to the head unit 40 side, the emitted heat of the transistor pair (transistors Q1, Q2) can be utilized for temperature management of the ink of the head 41. That is, the emitted heat of the drive signal generating section 48 can be effectively utilized to raise the ink temperature, without the use of a heater or the like. In so doing, reduced power consumption may be attained.

However, in this case, if too much heat is emitted by the transistor pair, there is a risk of the ink becoming heated excessively. Accordingly, in the present embodiment, through the further use of the Peltier elements 49, in cases where the amount of emitted heat of the transistor pair is too great, the amount of heat can be utilized for cooling (heat absorption). Ink temperature management by the head control section HC is described below.

(In Cases where Transistor Temperature is Equal to or Less than a Threshold Value)

In a case where the temperature of the transistor Q1 detected by the thermistor (not shown) is equal to or less than a threshold value, the head control section HC turns the switch 73 to OFF. In this case, the emitted heat of the transistor Q1 is conducted to the ink inside the head 41 via the heat-dissipating panel 72. Because of this, the temperature of the ink inside the head 41 can be made to rise. In this way, in cases where the detected temperature of the transistor Q1 is equal to or less than a threshold value, a mode of controlling the ink temperature inside the head 41 through conduction of emitted heat of the transistor pair to the ink inside the head 41 (this corresponds to the first heat conduction mode) is used. In so doing, the ink temperature can be raised without the use of a heater or the like. In the present embodiment, the transistor pair (heat-emitting body) is provided to the head 41 via the heat-dissipating panel 72. In so doing, because the heat emitted by the transistor pair is readily conducted to the heat-dissipating panel 72, the emitted heat of the transistor pair is readily conducted to the ink of the head 41.

(In Cases where Transistor Temperature Exceeds the Threshold Value)

In a case where the temperature of the transistor Q1 detected by the thermistor (not shown) exceeds the threshold value, the head control section HC turns the switch 73 to ON. Because of this, the heat emitted by the transistor Q1 is conducted to one of the junctions of the Peltier elements 49 via the heat-transfer member 71, and the temperature at the junction in question rises. Therefore, a temperature differential arises between the junctions of the Peltier elements 49, and voltage arises because of this temperature differential between junctions (the Seebeck effect). Because of this, current flows between the metals of the Peltier elements 49, and heat absorbing action is produced at the other junction (the heat-dissipating panel 72 side) (the Peltier effect).

In this way, a mode of transitioning the Peltier elements 49 to heat absorption (cooling) of the emitted heat, and conducting heat to the ink (this corresponds to the second heat conduction mode) is used in cases where the temperature of the transistor Q1 exceeds the threshold value. That is, the emitted heat of the transistor Q1 is used for cooling, with a greater amount of emitted heat of the transistor Q1 being associated with a greater amount of heat absorption at the heat-dissipating panel 72 side of the Peltier elements 49. Because of this, substantially constant ink temperature can be sustained despite the temperature of the transistor Q1 rising to exceed the threshold value. In this way, in cases where the detected temperature of the transistor Q1 exceeds the threshold value, ink temperature inside the head 41 is controlled utilizing heat absorption by the Peltier elements 49 using the emitted heat of the transistor Q1. In so doing, ink temperature can be controlled appropriately in cases of excessive emitted heat of the transistor Q1.

As shown in FIG. 7, in the present embodiment, the Peltier elements 49 are disposed at a position closer to the nozzle than the transistor Q1. That is, the Peltier elements 49 are disposed such that the spacing between the Peltier elements 49 and the nozzles is shorter than the spacing between the transistor Q1 and the nozzles. In so doing, the cooling capability of ink in proximity to the nozzle can be enhanced.

As described above, according to the present embodiment, the drive signal generating section 48 is provided to the head unit 40. The Peltier elements 49 are also provided to the head unit 40, in correspondence with the transistor pairs of the drive signal generating section 48. Ink temperature management is carried out using a mode of conducting emitted heat of the transistor Q1 directly to the ink of the head 41 for utilization in temperature control of the ink, and a mode of conducting emitted heat of the transistor Q1 to one of the junctions of the Peltier elements 49, then utilizing the heat absorbing action of the other junction. Because of this, substantially constant temperature of the ink inside the head 41 can be maintained even in cases where the amount of emitted heat of the transistor Q1 is excessive, and ink temperature control can be carried out appropriately.

In the present embodiment, the transistor Q1 and the Peltier element 49 are connected by the heat-transfer member 71 (and the switch 73), but the transistor Q2 and the Peltier elements 49 may be connected by a comparable configuration as well. Then, for example, during charging of the piezo elements 417 (heat emission by the transistor Q1), the transistor Q1 and the Peltier elements 49 may be connected, whereas during discharge of the piezo element 417 heat emission by the transistor Q2), the transistor Q2 and the Peltier elements 49 may be connected.

### Other Embodiments

While a printer and the like has been described by way of an embodiment, the aforedescribed embodiment is intended to aid in understanding of the invention, and should not be construed as limiting the invention. Various modifications and improvements of the invention may be made without departing from the spirit thereof, and these equivalents will necessarily be included within the scope of the invention. In particular, the embodiments set forth below are included within the scope of the invention.

### (Regarding the Printer)

The printer of the embodiment discussed above was a printer that repeatedly alternates between a dot-forming operation (pass) for forming dots as the head travels in the travel direction, and a conveyance operation for conveying the medium in the conveyance direction (a so-called serial printer). However, the type of printer is not limited to this. For example, a printer with a stationary head adapted to carry out printing by ejecting ink from the head as the medium is conveyed in opposition to the head (a so-called line printer) is also acceptable.

### (Regarding the Ink)

Because the embodiment discussed above is a printer embodiment, ink is ejected from the nozzles, but the ink may be water-based or oil-based. The fluid ejected from the nozzles is not limited to ink, however. For example, liquids (including water) that contain metal materials, organic materials (particularly polymer materials), magnetic materials, conductive materials, wiring materials, film-forming materials, electronic inks, process liquids, gene solutions, and the like may be ejected from the nozzles.

### (Regarding the Drive Signal Generating Section)

In the embodiment discussed above, the drive signal generating section 48 is provided to the head unit 40, but is it acceptable at a minimum to furnish the current amplification circuit 483 (specifically, the transistor pair of the transistors Q1 and Q2) to the head unit 40. For example, it would be acceptable to furnish the DAC 481 and the voltage amplification circuit 482 to the controller 60 side, while furnishing the current amplification circuit 483 to the head unit 40. In this case as well, the emitted heat of the transistor pair can be utilized for ink temperature management.

### (Regarding Control of the Switch 73)

In the present embodiment, the temperature of the transistor Q1 is detected by the thermistor (not shown), and ON/OFF switching of the switch 73 is controlled on the basis of the detection result thereof, but there is no limitation to this. For example, on the basis of the print data from the controller 60, it would be acceptable to turn the switch 73 ON in cases of high drive load in the head 41, and turn the switch 73 OFF in cases of low load.

What is claimed is:

1. A head unit comprising:
a head having nozzles;
driving elements for carrying out an operation to eject ink from the nozzles on the basis of a drive signal;
transistors for generating the drive signal, the transistors emitting heat when the drive signal is generated; and
a Peltier element provided correspondingly with respect to the transistors;
wherein temperature control of ink inside the head is carried out according to
a first heat conduction mode in which heat emitted by the transistor is conducted to the ink inside the head, and
a second heat conduction mode in which heat emitted by the transistors is conducted to one of the junctions of the Peltier element, whereby a transition is made to heat absorption at another junction of the Peltier element and heat is conducted to the ink inside the head.

2. The head unit according to claim 1, wherein
the head unit includes a detection section for detecting the temperature of the transistors; and
the second heat conduction mode is used in a case where a detection result of the detection section exceeds a threshold value.

3. The head unit according to claim 1, wherein
the transistors and the Peltier element are provided to the head interposed by a heat-dissipating body.

4. The head unit according to claim 1, wherein
a spacing between the Peltier element and the nozzles is smaller than a spacing between the transistors and the nozzles.

5. A printing device comprising:
a head having nozzles;
driving elements for carrying out an operation to eject ink from the nozzles on the basis of a drive signal;
transistors for generating the drive signal, the transistors being provided to the head and emitting heat when the drive signal is generated; and
a Peltier element provided to the head correspondingly with respect to the transistors; wherein
temperature control of ink inside the head is carried out according to
a first heat conduction mode in which heat emitted by the transistors is conducted to the ink inside the head, and
a second heat conduction mode in which heat emitted by the transistors is conducted to one of the junctions of the Peltier element, whereby a transition is made to heat absorption at another junction of the Peltier element and heat is conducted to the ink inside the head.

6. A printing method for a printing device comprising a head having nozzles for ejecting ink; driving elements for carrying out an operation to eject ink from the nozzles; transistors provided to the head; and a Peltier element provided correspondingly with respect to the transistors; wherein
the printing method includes
using the transistors and generating a drive signal;
controlling the temperature of ink inside the head according to a first heat conduction mode in which heat emitted by the transistors when the drive signal is generated is conducted to the ink inside the head, and a second heat conduction mode in which the heat emitted by the transistors when the drive signal is generated is conducted to one end of the Peltier element, a transition is made to heat absorption at another end of the Peltier element and heat is conducted to the ink inside the head; and
driving the driving elements according to the drive signal so that ink is ejected from the nozzles of the head.
